(19) United States
(12) Patent Application Publication
(10) Pub. No.: US 2019/0073210 A1
(43) Pub. Date: Mar. 7, 2019

(54) CONTROL APPARATUS, PROGRAM DISTRIBUTION METHOD, AND COMPUTER PROGRAM

(71) Applicant: Sumitomo Electric Industries, Ltd., Osaka-shi (JP)

(72) Inventor: Yuki Sano, Osaka-shi (JP)

(21) Appl. No.: 16/080,760

(22) PCT Filed: Oct. 11, 2016
(86) PCT No.: PCT/JP2016/080069

§ 371 Date: Aug. 29, 2018

(30) Foreign Application Priority Data
Mar. 2, 2016 (JP) 2016-039917
Jun. 23, 2016 (JP) 2016-124088

(51) Int. Cl. G06F 8/65; G06F 9/445; H04L 29/08

(52) U.S. Cl. CPC G06F 8/65; H04L 67/34; G06F 9/445

(57) ABSTRACT

A control apparatus according to one aspect of the present disclosure is a control apparatus configured to control download of an update program for an on-vehicle control device that controls a target device installed in a vehicle. The control apparatus includes: an acquisition unit configured to acquire determination information which is at least one of a communication index relating to a congestion situation of a communication line used for the download, and correlation information correlating with the congestion situation; and a processing unit configured to determine, based on the acquired determination information, the timing to execute a download process for the update program.

### TECHNICAL FIELD

The present invention relates to a control apparatus, a program distribution method, and a computer program.

This application claims priority on Japanese Patent Application No. 2016-039917 filed on Mar. 2, 2016 and Japanese Patent Application No. 2016-124088 filed on Jun. 23, 2016, the entire contents of which are incorporated herein by reference.

### BACKGROUND ART

A technique has been disclosed in which a gateway receives, from a management server, an update program for a control program of each of ECUs (Electronic Control Units) as on-vehicle control devices, and each ECU overwrites the old version of the control program with the new version of the control program by using the received update program, thereby remotely executing program updating for each ECU in the vehicle through wireless communication (refer to Patent Literature 1).

### CITATION LIST

### Patent Literature

PATENT LITERATURE 1: Japanese Laid-Open Patent Publication No. 2007-65856

### SUMMARY OF INVENTION

A control apparatus according to one embodiment is a control apparatus configured to control download of an update program for an on-vehicle control device that controls a target device installed in a vehicle. The control apparatus includes: an acquisition unit configured to acquire determination information which is at least one of a communication index relating to a congestion situation of a communication line used for the download, and correlation information correlating with the congestion situation; and a processing unit configured to determine, based on the acquired determination information, the timing to execute a download process for the update program.

A program distribution method according to another embodiment includes the steps of: acquiring determination information which is at least one of a communication index relating to a congestion situation of a communication line used for the download, and correlation information correlating with the congestion situation; and determining, based on the acquired determination information, the timing to execute a download process for the update program.

A computer program according to still another embodiment is a computer program for causing a computer to function as a control apparatus configured to control download of an update program for an on-vehicle control device that controls a target device installed in a vehicle. The computer program causes the computer to function as: an acquisition unit configured to acquire determination information which is at least one of a communication index relating to a congestion situation of a communication line used for the download, and correlation information correlating with the congestion situation; and a processing unit configured to determine, based on the acquired determination information, the timing to execute a download process for the update program.

### BRIEF DESCRIPTION OF DRAWINGS

FIG. 1 is a diagram showing an overall configuration of a program updating system according to an embodiment of the present disclosure.

FIG. 2 is a block diagram showing an internal configuration of a gateway.

FIG. 3 is a block diagram showing an internal configuration of an ECU.

FIG. 4 is a block diagram showing an internal configuration of a management server.

FIG. 5 is a sequence diagram showing an example of updating of a control program of the ECU.

FIG. 6 is a flowchart showing an example of a flow of a timing determination process in step S2 shown in FIG. 5.

FIG. 7 is a block diagram showing a specific example of a functional configuration of the management server.

### DESCRIPTION OF EMBODIMENTS

### Problems to be Solved by the Present Disclosure

According to the disclosure of Patent Literature 1, the update program for updating the control program is distributed from the server toward the gateway installed in the vehicle in response to a request from the vehicle side. Therefore, if distribution of the update program is requested at the time when congestion occurs in the communication line due to concentrated communication accesses, the distribution time may be increased or, in some cases, communication error may occur, which may cause distribution of the update program to fail. Further, since the traffic on the communication line is made heavier, other communications will be adversely affected.

An object in one aspect of the present disclosure is to provide a control apparatus, a program distribution method, and a computer program which are capable of efficiently distributing an update program, taking the communication state into account.

### EFFECT OF THE DISCLOSURE

According to this disclosure, it is possible to efficiently distribute an update program for an on-vehicle control device that controls a target device installed on a vehicle, taking the communication state of the communication line into account.

### Description of Embodiments

Embodiments of the present disclosure include at least the following.

That is, a control apparatus included in the present embodiments is a control apparatus configured to control download of an update program for an on-vehicle control device that controls a target device installed in a vehicle. The control apparatus includes: an acquisition unit configured to acquire determination information which is at least one of a communication index relating to a congestion situation of a communication line used for the download, and correlation information correlating with the congestion situation; and a processing unit configured to determine, based on the acquired determination information, the timing to execute a download process for the update program.

According to this configuration, the download process for the update program is executed at the timing based on at least one of the communication index relating to the congestion situation of the communication line used for the download, and the correlation information correlating with the congestion situation. Thus, it is possible to increase the possibility of avoiding the situation that congestion of the communication line causes an increase in the download time, or unsuccessful download. Further, influence of the download on the communication line can also be reduced.

Preferably, the processing unit determines the timing to execute the download process for the update program, in accordance with the quantity of the communication index.

Thus, the download process is executed at an appropriate timing, by setting a condition used for the determination to a condition that enables determination as to whether the communication state is a prescribed state in which the communication line is regarded as being congested.

Preferably, the correlation information includes an occurrence period of a first event that is specified temporally but is not specified geographically, the first event being a causing event that can cause the number of communication accesses to tighten the communication line. The processing unit determines the timing depending on whether or not a present time is included in the occurrence period of the first event.

Thus, the download process for the update program is executed at a timing based on the occurrence period of the first event that is the correlation information correlating with the congestion situation of the communication line used for the download. Through this, it is possible to increase the possibility of avoiding the situation that congestion of the communication line due to occurrence of the first event causes an increase in the download time, or unsuccessful download. Further, influence of the download on the communication line can also be reduced.

Preferably, the correlation information includes an occurrence period and an influence range of a second event that is specified temporally and geographically, the second event being a causing event that can cause the number of communication accesses to tighten the communication line. The processing unit determines the timing depending on whether or not a present time is included in the occurrence period of the second event, and whether or not the vehicle that requires the update program is included in the influence range of the second event.

Thus, the download process for the update program is executed at a timing based on the occurrence period and the influence range of the second event that is the correlation information correlating with the congestion situation of the communication line used for the download. Through this, it is possible to increase the possibility of avoiding the situation that congestion of the communication line due to occurrence of the second event causes an increase in the download time, or unsuccessful download. Further, influence of the download on the communication line can also be reduced.

Preferably, the download process is a process of notifying that the update program is downloadable, a process of starting download of the update program, or a process of changing the download speed of the update program.

Thus, download of the update program is started at an appropriate timing or executed at an appropriate speed. Therefore, it is possible to increase the possibility of avoiding the situation that congestion of the communication line causes an increase in the download time, or unsuccessful download. Further, influence of the download on the communication line can also be reduced.

Preferably, the processing unit determines the timing to execute the download process, in the case where the type of the update program is not an exceptional type.

Thus, it is possible to realize both importance/urgency of download of the update program, and prevention of problems that may occur due to transmission of the update program when the communication line is congested.

Preferably, the exceptional type is a type indicating that importance or urgency of the update program is high.

Thus, it is possible to realize both importance/urgency of the update program, and prevention of problems that may occur due to transmission of the update program when the communication line is congested.

Preferably, the processing unit determines the timing to execute the download process, at every certain period. In the case where the processing unit has not determined that it is time to execute the download process, and where it is predicted that, even after the certain period, the processing unit will not determine that it is time to execute the download process, the processing unit determines the timing to execute the download process after a period longer than the certain period has passed.

Thus, the timing of the download process for the update program is efficiently determined.

A distribution method included in the present embodiments is a method for distributing an update program for an on-vehicle control device that controls a target device installed in a vehicle. The method includes the steps of: acquiring determination information which is at least one of a communication index relating to a congestion situation of a communication line used for the download, and correlation information correlating with the congestion situation; and determining, based on the acquired determination information, the timing to execute a download process for the update program.

According to this configuration, the download process for the update program is executed at the timing based on at least one of the communication index relating to the congestion situation of the communication line used for the download, and the correlation information correlating with the congestion situation. Thus, it is possible to increase the possibility of avoiding the situation that congestion of the communication line causes an increase in the download time, or unsuccessful download. Further, influence of the download on the communication line can also be reduced.

A computer program included in the present embodiments is a computer program for causing a computer to function as a control apparatus configured to control download of an update program for an on-vehicle control device that controls a target device installed in a vehicle. The computer program causes the computer to function as: an acquisition unit configured to acquire determination information which is at least one of a communication index relating to a congestion situation of a communication line used for the download, and correlation information correlating with the congestion situation; and a processing unit configured to determine, based on the acquired determination information, the timing to execute a download process for the update program.

According to this configuration, the download process for the update program is executed at the timing based on at least one of the communication index relating to the congestion situation of the communication line used for the download, and the correlation information correlating with the congestion situation. Thus, it is possible to increase the possibility of avoiding the situation that congestion of the communication line causes an increase in the download time, or unsuccessful download. Further, influence of the download on the communication line can also be reduced.

### DETAILED DESCRIPTION OF EMBODIMENT

Hereinafter, preferred embodiments will be described with reference to the drawings. In the following description, the same reference numerals refer to the same components and constituent elements. The names and functions thereof are also the same. Therefore, repeated description thereof is not necessary.

### First embodiment

### [Overall Configuration of System]

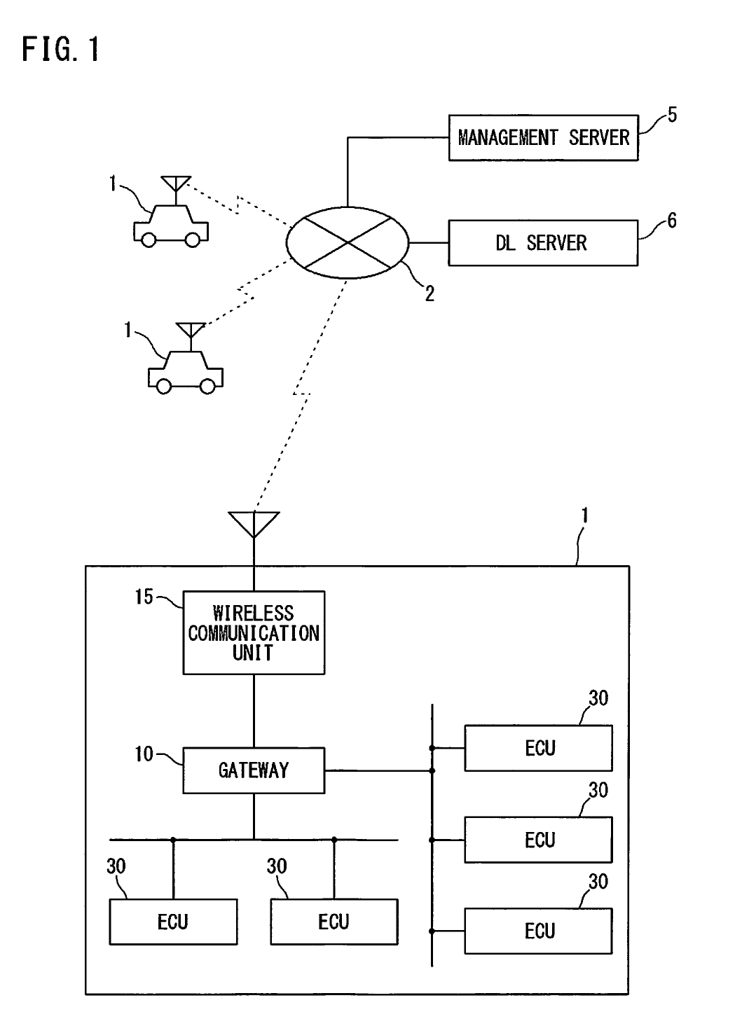

FIG. 1 is a diagram showing an overall configuration of a program updating system according to an embodiment of the present disclosure.

As shown in FIG. 1, the program updating system of this embodiment includes vehicles 1, a management server 5, and a DL (download) server 6 which are able to communicate with each other via a wide-area communication network 2.

The management server 5 and the DL server 6 are operated by, for example, the automobile manufacturer of the vehicles 1, and are able to communicate with large numbers of vehicles 1 owned by users registered as members in advance.

Each vehicle 1 is equipped with a gateway 10, a wireless communication unit 15, a plurality of ECUs 30, and various on-vehicle devices (not shown) controlled by the respective ECUs 30.

A plurality of communication groups, each being formed by a plurality of ECUs 30 bus-connected to a common in-vehicle communication line, are present in the vehicle 1, and the gateway 10 relays communication between the communication groups. Therefore, a plurality of in-vehicle communication lines are connected to the gateway 10.

The wireless communication unit 15 is communicably connected to the wide-area communication network 2 such as a mobile phone network, and is connected to the gateway 10 via an in-vehicle communication line. The gateway 10 transmits, to the ECUs 30, information received by the wireless communication unit 15 from external devices, such as the management server 5 and the DL server 6, through the wide-area communication network 2.

The gateway 10 transmits information obtained from the ECUs 30 to the wireless communication unit 15, and the wireless communication unit 15 transmits the information to the external devices such as the management server 5.

As for the wireless communication unit 15 installed in the vehicle 1, a device possessed by the user, such as a mobile phone, a smart phone, a tablet-type terminal, or a notebook PC (Personal Computer) is conceivable.

FIG. 1 shows an exemplary case where the gateway 10 communicates with the external devices via the wireless communication unit 15. However, if the gateway 10 has a wireless communication function, the gateway 10 itself may wirelessly communicate with the external devices such as the management server 5.

In the program updating system shown in FIG. 1, the management server 5 and the DL server 6 are configured as separated servers. However, these serves 5 and 6 may be configured as a single server unit.

### [Internal Configuration of Gateway]

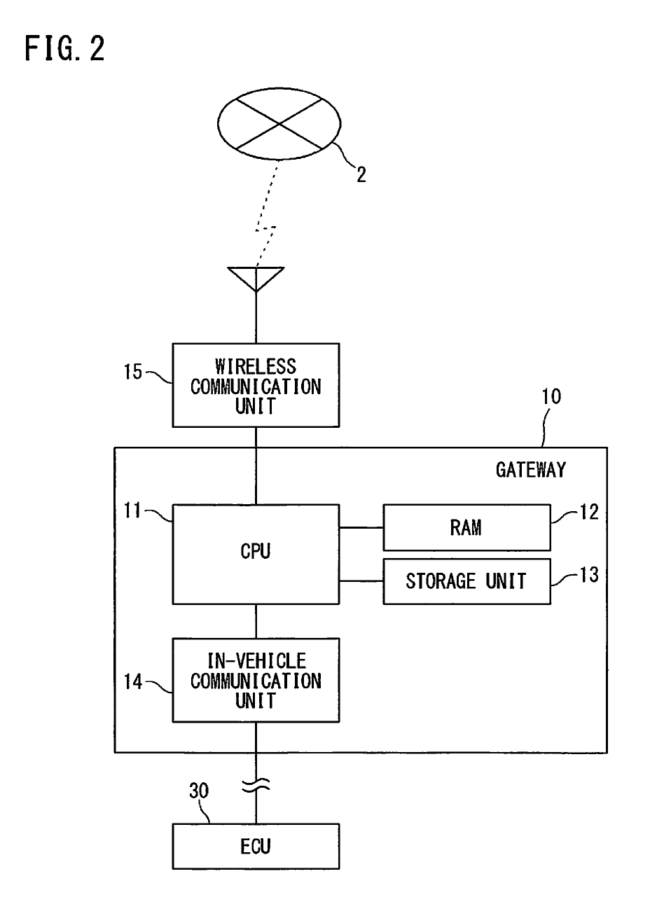

FIG. 2 is a block diagram showing the internal configuration of the gateway 10.

As shown in FIG. 2, the gateway 10 includes a CPU (Central Processing Unit) 11, an RAM (Random Access Memory) 12, a storage unit 13, an in-vehicle communication unit 14, and the like. Although the gateway 10 is connected to the wireless communication unit 15 via the in-vehicle communication line, the gateway 10 and the wireless communication unit 15 may be configured as a single unit.

The CPU 11 causes the gateway 10 to function as a relay device for relaying various kinds of information, by reading out one or a plurality of programs stored in the storage unit 13 to the RAM 12 and executing the read programs.

The CPU 11 can execute a plurality of programs in parallel by switching between the plurality of programs in a time sharing manner, for example. The CPU 11 may be a CPU representing a plurality of CPU groups. In this case, a function to be implemented by the CPU 11 is a function to be implemented by the plurality of CPU groups in cooperation with each other. The RAM 12 consists of a memory element such as an SRAM (Static RAM) or a DRAM (Dynamic RAM), and temporarily stores therein programs to be executed by the CPU 11, data required in executing the programs, and the like.

A computer program implemented by the CPU 11 can be transferred in a state of being recorded in a well-known recording medium such as a CD-ROM or a DVD-ROM, or may be transferred by data transmission (download) from a computer device such as a server computer.

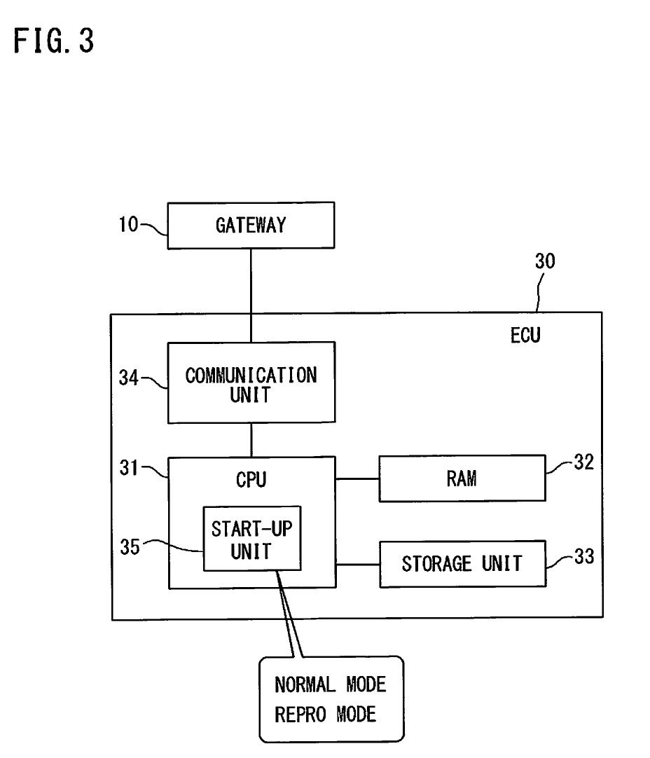

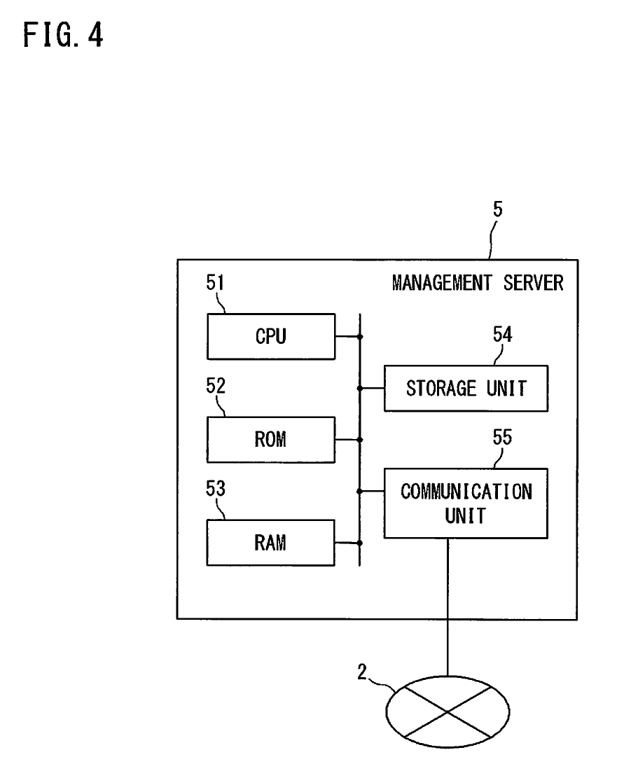

In this aspect, the same applies to a computer program to be executed by a CPU 31 of the ECU 30 (refer to FIG. 3) described later, and a computer program to be executed by a CPU 51 of the management server 5 (refer to FIG. 4) described later.

The storage unit 13 consists of, for example, a nonvolatile memory element such as a flash memory or an EEPROM (Electrically Erasable Programmable Read Only Memory).

The storage unit 13 has a storage area in which programs to be executed by the CPU 11, data required in executing the programs, and the like are stored. In the storage unit 13, update programs of the respective ECUs 30, received from the DL server 6, and the like are also stored.

The plurality of ECUs 30 are connected to the in-vehicle communication unit 14 via the in-vehicle communication lines arranged in the vehicle 1. The in-vehicle communication unit 14 communicates with the ECUs 30 in accordance with a standard such as CAN (Controller Area Network), CANFD (CAN with Flexible Data Rate), LIN (Local Interconnect Network), Ethernet (registered trademark), or MOST (Media Oriented Systems Transport: MOST is a registered trademark), for example.

The in-vehicle communication unit 14 transmits information provided from the CPU 11 to target ECUs 30, and provides information received from the ECUs 30 to the CPU 11. The in-vehicle communication unit 14 may communicate with the ECUs 30 in accordance with other communication standards that are used for an on-vehicle network, apart from the above communication standards.

The wireless communication unit 15 consists of a wireless communication apparatus including an antenna and a communication circuit that executes transmission/reception of radio signals through the antenna. The wireless communication unit 15 is able to communicate with the external devices when being connected to the wide-area communication network 2 such as a mobile phone network.

The wireless communication unit 15 transmits information provided from the CPU 11 to the external devices such as the management server 5 via the wide-area communication network 2 formed by a base station (not shown), and provides information received from the external devices to the CPU 11.

Instead of the wireless communication unit 15 shown in FIG. 2, a wired communication unit that serves as a relay device inside the vehicle 1 may be adopted. The wired communication unit has a connector to which a communication cable conforming to a standard such as USB (Universal Serial Bus) or RS232C is connected, and performs wired communication with another communication device connected thereto via the communication cable.

If the other communication device and the external device such as the management server 5 can wirelessly communicate with each other via the wide-area communication network 2, the external device and the gateway 10 are able to communicate with each other through a communication path consisting of, in order, the external device, the other communication device, the wired communication unit, and the gateway 10.

### [Internal Configuration of ECU]

FIG. 3 is a block diagram showing the internal configuration of an ECU 30.

As shown in FIG. 3, the ECU 30 includes a CPU 31, an RAM 32, a storage unit 33, a communication unit 34, and the like. The ECU 30 is an on-vehicle control device that individually controls a target device installed in the vehicle 1. Examples of the types of the ECU 30 include an engine control ECU, a steering control ECU, and a door lock control ECU.

The CPU 31 controls the operation of a target device that the CPU 31 is in charge of, by reading out one or a plurality of programs previously stored in the storage unit 33 to the RAM 32 and executing the read programs. The CPU 31 may also be a CPU representing a plurality of CPU groups, and a control to be performed by the CPU 31 may be a control to be performed by the plurality of CPU groups in cooperation with each other.

The RAM 32 consists of a memory element such as an SRAM or a DRAM, and temporarily stores therein programs to be executed by the CPU 31, data required in executing the programs, and the like.

The storage unit 33 consists of, for example, a nonvolatile memory element such as a flash memory or an EEPROM, or a magnetic storage device such as a hard disk.

Information stored in the storage unit 33 includes, for example, a computer program (hereinafter referred to as “control program”) that causes the CPU 31 to execute information processing for controlling a target device to be controlled, inside the vehicle.

The gateway 10 is connected to the communication unit 34 via the in-vehicle communication lines arranged in the vehicle 1. The communication unit 34 communicates with the gateway 10 in accordance with a standard such as CAN, Ethernet, or MOST, for example.

The communication unit 34 transmits information provided from the CPU 31 to the gateway 10, and provides information received from the gateway 10 to the CPU 31. The communication unit 34 may communicate with the gateway 10 in accordance with other communication standards that are used for the on-vehicle network, apart from the above communication standards.

The CPU 31 of the ECU 30 includes a start-up unit 35 that switches the mode of control performed by the CPU 31, between a “normal mode” and a “reprogramming mode” (hereinafter also referred to as “repro mode”).

The normal mode is a control mode in which the CPU 31 of the ECU 30 executes original control for the target device (e.g., engine control for a fuel engine, or door lock control for a door lock motor).

The reprogramming mode is a control mode in which the CPU 31 updates the control program used for controlling the target device.

That is, the reprogramming mode is a control mode in which the CPU 31 performs erasing/overwriting of the control program from/on an ROM area in the storage unit 33. Only when the CPU 31 is in this control mode, the CPU 31 is allowed to update the control program stored in the ROM area in the storage unit 33 to a new version of the control program.

When the CPU 31, in the repro mode, writes the new version of the control program into the storage unit 33, the start-up unit 35 temporarily restarts (resets) the ECU 30, and executes a verifying process on a storage area where the new version of the control program has been written.

After completion of the verifying process, the start-up unit 35 operates the CPU 31 with the updated control program.

### [Internal Structure of Management Server]

FIG. 4 is a block diagram showing the internal structure of the management server 5.

As shown in FIG. 4, the management server 5 includes a CPU 51, an ROM 52, an RAM 53, a storage unit 54, a communication unit 55, and the like.

By reading out one or a plurality of programs previously stored in the ROM 52 to the RAM 53 and executing the read programs, the CPU 51 controls the operation of each hardware component, and causes the management server 5 to function as an external device that is able to communicate with the gateway 10. The CPU 51 may also be a CPU representing a plurality of CPU groups, and a function to be implemented by the CPU 51 may be a function to be implemented by the plurality of CPU groups in cooperation with each other.

The RAM 53 consists of a memory element such as an SRAM or a DRAM, and temporarily stores therein programs to be executed by the CPU 51, data required in executing the programs, and the like.

The storage unit 54 consists of, for example, a nonvolatile memory element such as a flash memory or an EEPROM, or a magnetic storage device such as a hard disk.

The communication unit 55 consists of a communication device that executes a communication process in accordance with a predetermined communication standard. The communication unit 55 executes the communication process when being connected to the wide-area communication network 2 such as a mobile phone network. The communication unit 55 transmits information provided from the CPU 51 to external devices via the wide-area communication network 2, and provides information received via the wide-area communication network 2 to the CPU 51.

### [Control Program Updating Sequence]

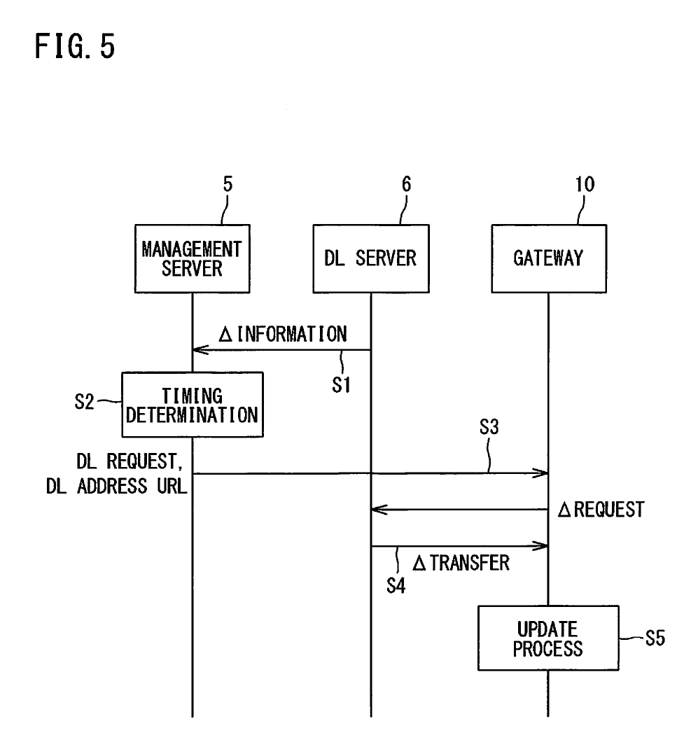

FIG. 5 is a sequence diagram showing an example of updating of a control program for an ECU, which is executed in the program updating system of the present embodiment. For example, as for a vehicle 1 that is owned by a user registered as a member in advance, the management server 5 determines the timing to update a control program of an ECU of the vehicle 1. The timing of updating may be set by, for example, the automobile manufacturer of the vehicle 1.

Preferably, before the timing to update the control program, the management server 5 acquires update information that is information regarding the update program, from the DL server 6 in which the update program is stored (step S1). Examples of the update information include: information regarding the data size of the update program; and information regarding the type of the update program.

The management server 5 executes a timing determination process (step S2). The timing determination process is a process in which the timing to execute a download process, which is a process regarding download (transmission) of the update program to the gateway 10 of the corresponding vehicle 1, is determined based on, for example, information correlating with the congestion situation of the communication line used for transmission of the update program. Upon determining that it is time to execute the download process, the management server 5 notifies the gateway 10 of the corresponding vehicle 1 that the update program for the ECU 30 is present (step S3). In step S3, the management server 5 transmits, for example, a download request and a URL where the update program is stored, to the gateway 10 of the corresponding vehicle 1.

Through this, the gateway 10 requests the update program for the ECU 30, and downloads the update program from the DL server 6 (step S4).

When the update program has been downloaded, the gateway 10 executes an update process so as to update the control program by using the update program having been downloaded and stored in the memory (step S5). In the update process in step S5, for example, the gateway 10 requests the corresponding ECU 30 to update the control program. Through this, the control mode of the ECU 30 is switched from the normal mode to the repro mode, and the ECU 30 becomes able to perform the update process for the control program. The ECU 30 expands the update program received from the gateway 10 and applies the update program to the old version of the control program, thereby overwriting the old version of the control program with the new version of the control program.

### [Timing Determination Process]

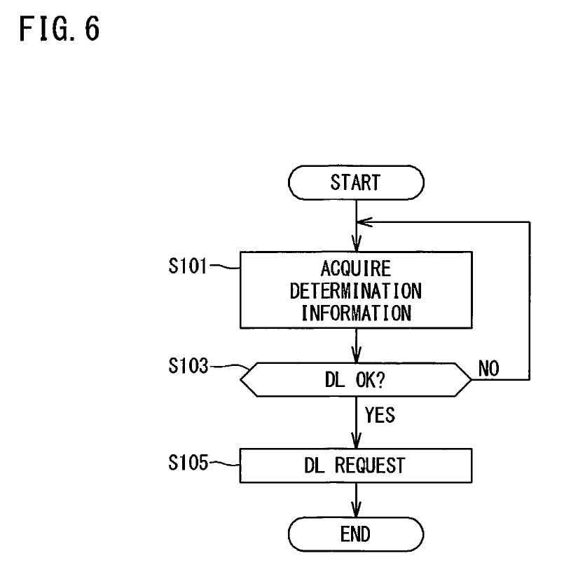

FIG. 6 is a flowchart showing the specific content of the timing determination process in step S2 shown in FIG. 5. The process shown in the flowchart of FIG. 6 is implemented mainly by the CPU 51 of the management server 5 such that the CPU 51 reads out the programs stored in the ROM 52 to the RAM 53 and executes the read programs.

With reference to FIG. 6, the CPU 51 of the management server 5 acquires determination information that is information used for timing determination (step S101). The determination information acquired in step S101 is at least one of: a communication index relating to the congestion situation of the wide-area communication network 2, such as a mobile phone network, for transmitting the update program; and correlation information correlating with the congestion situation.

Based on the determination information, the CPU 51 determines the timing to execute the download process for the update program (step S103). Upon determining that it is time to execute the download process (YES in step S103), the CPU 51 performs the notification in step S3 in FIG. 5, that is, requests the gateway 10 of the corresponding vehicle 1 to execute download (step S105). That is, in this case, in the program updating system, download of the update program is started.

On the other hand, when the CPU 51 has not determined, based on the communication state of the wide-area communication network 2, that it is time to execute the download process (NO in step S103), the CPU 51 does not perform the notification in step S3 in FIG. 5, that is, does not request the gateway 10 of the corresponding vehicle 1 to execute download. That is, in this case, download of the update program is not started in the program updating system. In this case, the CPU 51 periodically repeats the operation from step 5101 at predetermined intervals.

Specifically, in step S103, in the case where the determination information satisfies a prescribed determination condition, the CPU 51 does not determine that it is time to execute the download process. Otherwise, the CPU 51 determines that it is time to execute the download process. The determination condition is a condition for determining whether or not the communication state in the wide-area communication network 2 is a prescribed state in which the wide-area communication network 2 is regarded as being congested to a prescribed degree (congestion degree).

Since the timing determination process in step S2 is executed, in the case where the determination condition is satisfied, download of the update program is not started until the determination condition becomes unsatisfied. When the communication state is restored to the state in which the determination condition is not satisfied, download of the update program is started. That is, in the case where it has been determined, based on the determination condition, that the communication state of the wide-area communication network 2 is the prescribed state such as the congestion state in which the wide-area communication network 2 is regarded as being congested, download of the update program is not started until this state is resolved, that is, until the congested communication state is regarded as being resolved. In other words, in the program updating system, the timing to download the update program is determined based on the information relating to or correlating with the congestion situation of the wide-area communication network 2.

### [Functional Configuration of Management Server]

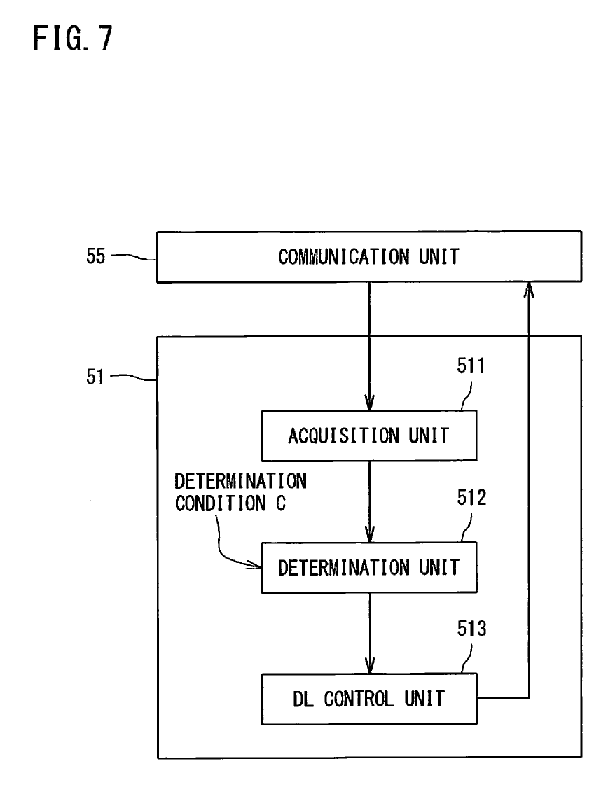

FIG. 7 is a block diagram showing a specific example of the functional configuration of the management server 5 for performing the aforementioned timing determination process. Functions shown in FIG. 7 are implemented mainly by the CPU 51 of the management server 5 such that the CPU 51 reads out the programs stored in the ROM 52 to the RAM 53 and executes the read programs.

Specifically, with reference to FIG. 7, the CPU 51 of the management server 5 includes: an acquisition unit 511 for acquiring the determination information; a determination unit 512 that is a processing unit for determining the timing to execute the download process by using the determination information; and a DL control unit 513 for controlling the download process.

The determination information is at least one of: a communication index relating to the congestion situation of the wide-area communication network 2, such as a mobile phone network, for transmitting the update program; and correlation information correlating with the congestion situation. The determination information is information according to a later-described timing determination method used by the determination unit 512. The determination unit 512 stores, in advance, a determination condition C according to the timing determination method. The determination condition C includes a threshold or a condition for determining whether or not the communication state is the prescribed state such as the congestion state in which the wide-area communication network 2 is regarded as being congested. The determination unit 512 determines whether or not the acquired determination information satisfies the determination condition C, and determines the timing to execute the download process, based on the determination result. When the determination information satisfies the determination condition C, that is, when the determination unit 512 has determined that the communication state is the prescribed state such as the congestion state in which the wide-area communication network 2 is regarded as being congested, the determination unit 512 does not determine that it is time to execute the download process. When the determination information does not satisfy the determination condition C, the determination unit 512 determines that it is time to execute the download process.

The DL control unit 513 executes the download process for the control program. The download process is, for example, a process of notifying the gateway 10 that the downloadable update program is present (step S3) as described above. In the case where the management server 5 and the DL server 6 are configured as a single server unit as described above, the download process may be the start of transmission (download) of the update program to the gateway 10.

### (Timing Determination Method 1)

As a first method for determining the timing to execute the download process by the determination unit 512, a method of determining the timing in accordance with the quantity of the communication index relating to the congestion situation of the wide-area communication network 2 such as a mobile phone network, is conceivable.

In this case, the acquisition unit 511 acquires, as the determination information, for example, measured values of: the number of packets transmitted in the wide-area communication network 2; communication traffic; communication speed; and the like. It is assumed that these values are measured by, for example, a carrier managing the wide-area communication network 2, and are provided in a website or the like. The acquisition unit 511 stores therein the URL of the website in advance, and acquires the measured values as the determination information from the website.

The determination unit 512, for example, stores therein the maximum number of transmittable packets, the communication traffic, and the communication speed in the wide-area communication network 2, and calculates, as the communication index relating to the congestion situation, the present utilization rate of the wide-area communication network 2. The utilization rate is calculated by dividing, for example, the number of packets indicated by the determination information, by the maximum number of transmittable packets. Alternatively, the utilization rate may be calculated by the carrier managing the wide-area communication network 2, and may be provided as the communication index relating to the congestion situation. In this case, the acquisition unit 511 acquires the utilization rate as the determination information from the website.

The determination unit 512 stores, in advance, as the determination condition C, a threshold of the utilization rate, for determining whether or not the communication state is the prescribed state in which the communication line is regarded as being congested. The threshold of the utilization rate is 85%, for example. The determination unit 512 compares the present utilization rate as the communication index with the threshold of the utilization rate.

The determination unit 512 determines the timing to execute the download process, based on the result of the comparison. That is, in this case, if the utilization rate is less than 85%, the determination unit 512 determines that it is time to execute the download process. Otherwise, the determination unit 512 does not determine that it is time to execute the download process.

Alternatively, the determination unit 512 may predict the present communication index by using, as the determination information, previously measured values of the number of packets transmitted in the wide-area communication network 2, the communication traffic, and the communication speed, and may determine the timing to execute the download process, based on the predicted value of the communication index.

In this case, the acquisition unit 511 acquires, as the determination information, the previously measured values of the number of packets transmitted in the wide-area communication network 2, the communication traffic, and the communication speed. The previously measured values are, for example, the values that have been measured during a predetermined period (e.g., one week) from the present time. The determination unit 512 sets, for example, the values measured at the same time of day or on the same day of the week as the present time, as expected values of the number of packets, the communication traffic, and the communication speed at the present time. Then, the determination unit 512 calculates, as described above, the utilization rate as the predicted value of the communication index by using the expected values, and compares the utilization rate with the threshold to determine the timing to execute the download process.

### (Timing Determination Method 2-1)

As a second method for determining the timing to execute the download process by the determination unit 512, a determination method based on correlation information correlating with the congestion situation of the wide-area communication network 2 such as a mobile phone network, is conceivable. The correlation information is information relating to a causing event that may cause the number of communication accesses to tighten the communication line. The event is, for example, an event that is specified only temporally, that is, an event (first event) that is specified temporally but is not specified geographically. The first event is an event that is specified by a prescribed period in a year, such as year-end and New Year holidays, O-bon holidays, Christmas holidays, Golden Week holidays, or Halloween holidays. In this case, the correlation information includes a period during which the event occurs.

The correlation information as the determination information is stored in the storage unit 54 in advance, and the acquisition unit 511 reads out the correlation information from the storage unit 54 to acquire the determination information. The occurrence period of each event is stored in the storage unit 54 in advance by an automobile manufacturer, for example. Alternatively, the acquisition unit 511 may access a server (not shown) providing the correlation information to acquire the determination information.

The determination unit 512 stores, in advance, as the determination condition C, a condition as to whether or not the present date and time is included in the occurrence period of the event, which is a condition for determining whether or not the communication state is the prescribed state in which the communication line is regarded as being congested. The determination unit 512 compares the present date and time with the occurrence period of the event to determine the timing to execute the download process. That is, when the present date and time is not included in the occurrence period of the event, the determination unit 512 determines that it is time to execute the download process. Otherwise, the determination unit 512 does not determine that it is time to execute the download process.

### (Timing Determination Method 2-2)

In another example, the causing event is an event (second event) that is specified temporally and geographically. Examples of the event include: entertainment events such as sports events (games, athletic meetings, etc.), music events (concerts, etc.), and festivals; large-scale accidents such as explosions, public traffic accidents, and terrorist attacks; and natural phenomena such as abnormal weather (typhoons, local downpours, floods, etc.), and natural disasters (earthquakes, tsunamis, etc.). In this case, the correlation information includes the occurrence period and influence range of the event.

At least a part of the correlation information as the determination information is stored in the storage unit 54 in advance, and the acquisition unit 511 reads out the information from the storage unit 54 to acquire at least a part of the determination information. Alternatively, the acquisition unit 511 may access a server (not shown) providing at least a part of the correlation information to acquire the determination information. For example, in the case where the event is a natural disaster such as an earthquake, the acquisition unit 511 can acquire the area and the date and time where/when the disaster occurred by accessing the website of the Japan Meteorological Agency. In this case, as the correlation information, for example, information indicating that the occurrence period is one week from the occurrence date and time, and that the influence range covers the prefectures adjacent to the prefecture including the occurrence area, is stored in the storage unit 54. Such correlation information may be settable/modifiable with respect to the management server 5 by, for example, the operator of the DL server 6 or the automobile manufacturer. The acquisition unit 511 can specify the occurrence period and the influence range of the natural disaster event such as an earthquake by reading out the correlation information from the storage unit 54.

Further, the acquisition unit 511 acquires, as the determination information, the present position of the vehicle 1. Positional information indicating the present position of the vehicle 1 is acquired, for example, through communication with the gateway 10 of the vehicle 1. The gateway 10 can obtain the positional information of the vehicle 1 by, for example, communicating with a navigation device (not shown), or communicating with a GPS (Global Positioning System).

The determination unit 512 stores, in advance, as the determination condition C, a condition that the present date and time is included in the occurrence period of the event, and that the present position of the vehicle 1 is included in the influence range of the event, as the condition for determining whether or not the communication state is the prescribed state in which the communication line is regarded as being congested. The determination unit 512 compares the present date and time with the occurrence period of the event and compares the present position of the vehicle 1 with the influence range of the event, thereby determining the timing to execute the download process. That is, in the case where the present date and time is not included in the occurrence period of the event or where the present position of the vehicle 1 is not included in the influence range of the event, that is, in the case where the determination condition C is not satisfied, the determination unit 512 determines that it is time to execute the download process. Otherwise, the determination unit 512 does not determine that it is time to execute the download process.

### (Timing Determination Method 3)

As a third method for determining the timing to execute the download process by the determination unit 512, a combination of the first method and the second method may be used. That is, the timing may be determined based on both the communication index relating to the congestion situation of the wide-area communication network 2 such as a mobile phone network, and the correlation information correlating with the congestion situation.

### Effect of First Embodiment

According to the program updating system of the first embodiment, download of the update program for each ECU is started at an appropriate timing based on the communication index relating to the congestion situation of the wide-area communication network 2 and/or the correlation information correlating with the congestion situation. That is, download of the update program is not started in the case where the determination condition indicating the prescribed state in which the wide-area communication network 2 is regarded as being congested, is satisfied; otherwise, download of the update program is started. Thus, it is possible to increase the possibility of avoiding the situation that congestion of the wide-area communication network 2 causes an increase in the download time of the update program, or unsuccessful download. Further, it is possible to increase the possibility of avoiding the situation that download of the update program causes further congestion of the wide-area communication network 2, or delay in resolving the congestion.

Since the timing to execute the download process is determined by using the determination condition C based on the correlation information that correlates with the congestion situation of the wide-area communication network 2, even when the communication index relating to the congestion situation, such as the measured values (actually measured values) of the number of packets transmitted in the wide-area communication network 2, the communication traffic, and the communication speed, cannot be obtained, it is possible to determine the timing to execute the download process with high accuracy.

### Second Embodiment

In a program updating system according to a second embodiment, in the case where the update information of the update program to be downloaded includes type information indicating that the update program is of an exceptional type, the timing to execute the download process is determined without the timing determination process being performed. The exceptional type is information indicating the type of the update program, such as importance of the update program or urgency of updating, and may be flag information such as an importance flag or an urgency flag. Examples of the exceptional update program include: an update program regarding information security such as a countermeasure to a security hole: an update program necessary for ensuring safety in traveling; and an update program having high urgency of updating, such as map information used for an automatic operation mode. The exceptional types such as importance of the update program and urgency of updating are set by, for example, the automobile manufacturer providing the update program.

In the case where the update information regarding the update program to be transmitted includes the type information indicating the aforementioned exceptional type, the determination unit 512 determines that it is time to execute the download process without performing the timing determination process. In this case, the update program is transmitted to the corresponding vehicle 1 regardless of the congestion situation of the wide-area communication network 2. That is, an update program having high importance or urgency is transmitted even when the communication on the wide-area communication network 2 is congested to some extent, while other update programs are transmitted at timings determined by using the determination condition C. Thus, it is possible to ensure both importance/urgency of the update program, and prevention of problems that may occur due to transmission of the update program when the communication on the wide-area communication network 2 is congested.

The exceptional type may be the data size being equal to or smaller than a prescribed size. The data size of an update program is added as update information to the update program by the automobile manufacturer or the like providing the update program. In this case, the determination unit 512 stores, in advance, a threshold of a data size that does not require the timing determination process. This threshold is a data size that does not greatly affect the communication on the wide-area communication network 2. In the case where the data size of the update program is smaller than the threshold, the determination unit 512 determines that it is time to execute the download process, without performing the timing determination process. Otherwise, the determination unit 512 executes the timing determination process. Thus, the update program having the small data size is transmitted even when the communication on the wide-area communication network 2 is congested to some extent, while other update programs are transmitted at timings determined by using the determination condition C. Thus, it is possible to effectively avoid the problems that may occur due to transmission of the update program when the communication on the wide-area communication network 2 is congested.

### Third Embodiment

In the timing determination process shown in FIG. 6, when it has not been determined that it is time to execute the download process (NO in step S103), the timing determination process is repeated again after a certain period such as one day (24 hours) has passed. That is, the timing determination process is periodically performed. At this time, in the program updating system according to the third embodiment, in the case where it is predicated that, even after the certain period, it will not be determined that it is time to execute the download process, the timing determination process is performed after a period longer than the certain period has passed, regardless of the aforementioned cycle.

Specifically, in the case where the event information of the first event is used as the determination information (timing determination method 2-1), the determination unit 512 predicts, at the time point when the determination unit 512 has not determined that it is time to execute the download process, whether or not the date and time after the certain period is still included in the occurrence period of the event. According to the result of the prediction, the determination unit 512 determines whether a period until execution of the next timing determination process should be set to the aforementioned certain period or a period longer than the certain period. For example, it is assumed that the timing determination process has been performed at 9 a.m. on December 31 and then it is not determined that it is time to execute the download process because this time point is included in the year-end and New Year period (e.g., from 9 a.m. on December 31 to 12 a.m. on January 1), and that the aforementioned certain period is one day (24 hours). In this case, at 9 a.m. on December 31, it is predicted that the time point one day after the above time point, i.e., 9 a.m. on January 1, is still included in the year-end and New year period. Then, the determination unit 512 executes the timing determination process after a period longer than the prescribed certain period (one day) has passed, for example, on January 2.

According to the program updating system of the third embodiment, in the case where the timing determination process has not determined that it is time to execute the download process for the update program, the timing determination process is performed again at an appropriate time. That is, the timing determination process is not performed again at the timing when determination that it is time to execute the download process is predicted not to be made, and therefore, the timing to execute the download process for the update program can be efficiently determined.

### Fourth Embodiment

As another example of the download process, a process for controlling the communication speed of the update program is conceivable. Control of the communication speed of the update program is, for example, control of the transmission cycle or control of the transmission rate (amount of transmission data per unit time). For example, in the case of the example shown in FIG. 5, in step S3, the management server 5 requests the gateway 10 to perform download while specifying the transmission cycle or the download speed (communication speed). In this case, the DL control unit 513 controls the transmission cycle of the update program or the transmission rate such as the amount of transmission data per unit time.

Specifically, in the case where the determination unit 512 has executed the timing determination process and determined that the determination condition C is satisfied, that is, in the case where the determination unit 512 has determined that the communication state is the prescribed state in which the wide-area communication network 2 is regarded as being congested, the DL control unit 513 performs control so as to transmit the update program at a second communication speed that is lower than a first communication speed that is a predetermined normal speed. Otherwise, the DL control unit 513 performs control so as to transmit the update program at the first communication speed.

According to the program updating system of the fourth embodiment, it is possible to increase the possibility of avoiding unsuccessful download of the update program, which may be caused by congestion of the wide-area communication network 2. Further, it is also possible to reduce influence of download of the update program on the wide-area communication network 2.

### Fifth Embodiment

In the program updating system according to any of the first to fourth embodiments, the timing determination process is executed by the management server 5 which is a control apparatus executing the download process for the update program. In the example shown in FIG. 5, the update program is downloaded from the DL server 6 in response to the request for the update program from the gateway 10. Therefore, the gateway 10 can also be regarded as the control apparatus. Thus, the timing determination process may be performed by the gateway 10 which is an example of the control apparatus.

In this case, the respective functions shown in FIG. 7 are implemented by the CPU 11 of the gateway 10 such that the CPU 11 reads out the programs stored in the storage unit 13 to the RAM 12 and executes the read programs. Upon being notified of the update program by the management server 5 in step S3, the gateway 10 executes the timing determination process, requests the update program from the DL server 6 at timing determined based on the communication state of the wide-area communication network 2, and downloads the update program.

[Supplementary Notes 1]

The embodiments of the present disclosure may further include the following.

That is, a control apparatus included in the embodiments of the present disclosure is a control apparatus configured to control download of an update program for an on-vehicle control device that controls a target device installed in a vehicle. The control apparatus includes: an acquisition unit configured to acquire determination information which is at least one of a communication index of a communication line used for the download, and information regarding a causing event that causes the number of communication accesses to tighten the communication line; and a processing unit configured to determine, based on the acquired determination information, timing to execute the download of the update program.

### [Supplementary Notes 2]

It is noted that the embodiments disclosed herein are merely illustrative in all aspects and should not be recognized as being restrictive. The scope of the present invention is defined not by the above description but by the scope of the claims, and is intended to include meaning equivalent to the scope of the claims and all modifications within the scope.

### REFERENCE SIGNS LIST

1 vehicle

2 wide-area communication network

5 management server (control apparatus)

6 DL server

10 gateway (control apparatus)

11 CPU

12 RAM

13 storage unit

14 in-vehicle communication unit

15 wireless communication unit

30 ECU (on-vehicle control device)

31 CPU

32 RAM

33 storage unit

34 communication unit

35 start-up unit

51 CPU

52 ROM

53 RAM

54 storage unit

55 communication unit

511 acquisition unit

512 determination unit (processing unit)

513 DL control unit

1. A control apparatus configured to control download of an update program for an on-vehicle control device that controls a target device installed in a vehicle, the control apparatus comprising:
an acquisition unit configured to acquire determination information which is at least one of a communication index relating to a congestion situation of a communication line used for the download, and correlation information correlating with the congestion situation; and
a processing unit configured to determine, based on the acquired determination information, a timing to execute a download process for the update program, wherein
the correlation information is an occurrence period and an influence range of an event that causes the number of communication accesses to tighten the communication line, and that is specified temporally and geographically, and
the processing unit determines the timing depending on whether or not a present time is included in the occurrence period of the event, and whether or not the vehicle that requires the update program is included in the influence range of the event.

2. The control apparatus according to claim 1, wherein the processing unit determines the timing in accordance with the quantity of the communication index.

3. The control apparatus according to claim 1, wherein
the correlation information further includes an occurrence period of a first an event that is specified temporally but is not specified geographically,
the processing unit determines the timing depending on whether or not a present time is included in the occurrence period of the event.

4. (canceled)

5. The control apparatus according to claim 1, wherein the download process is a process of notifying that the update program is downloadable, a process of starting download of the update program, or a process of changing a download speed of the update program.

6. The control apparatus according to claim 1, wherein the processing unit determines the timing to execute the download process, in a case where the type of the update program is not an exceptional type.

7. The control apparatus according to claim 6, wherein the exceptional type is a type indicating that importance or urgency of the update program is high.

8. The control apparatus according to claim 1, wherein
the processing unit determines the timing to execute the download process, at every certain period, and
in a case where the processing unit has not determined that it is time to execute the download process and where it is predicted that, even after the certain period, the processing unit will not determine that it is time to execute the download process, the processing unit determines the timing to execute the download process after a period longer than the certain period has passed.

9. A method for distributing an update program for an on-vehicle control device that controls a target device installed in a vehicle, the method comprising the steps of:
acquiring determination information which is at least one of a communication index relating to a congestion situation of a communication line used for the download, and correlation information correlating with the congestion situation; and
determining, based on the acquired determination information, a timing to execute a download process for the update program, wherein
the correlation information is an occurrence period and an influence range of an event that causes the number of communication accesses to tighten the communication line, and that is specified temporally and geographically, and
the determining step comprises determining the timing depending on whether or not a present time is included in the occurrence period of the event, and whether or not the vehicle that requires the update program is included in the influence range of the event.

10. A non-transitory computer readable storage medium storing a computer program to control download of an update program for an on-vehicle control device that controls a target device installed in a vehicle, the computer program causing the computer to execute the steps of:
acquiring determination information which is at least one of a communication index relating to a congestion situation of a communication line used for the download, and correlation information correlating with the congestion situation; and
determining, based on the acquired determination information, a timing to execute a download process for the update program, wherein
the correlation information is an occurrence period and an influence range of an event that causes the number of communication accesses to tighten the communication line, and that is specified temporally and geographically, and
the determining step comprises determining the timing depending on whether or not a present time is included in the occurrence period of the event, and whether or not the vehicle that requires the update program is included in the influence range of the event.

11. A control apparatus configured to control download of an update program for an on-vehicle control device that controls a target device installed in a vehicle, the control apparatus comprising:
an acquisition unit configured to acquire determination information which is at least one of a communication index relating to a congestion situation of a communication line used for the download, and correlation information correlating with the congestion situation; and
a processing unit configured to determine, based on the acquired determination information, a timing to execute a download process for the update program at every certain period, wherein
in a case where the processing unit has not determined that it is time to execute the download process and where it is predicted that, even after the certain period, the processing unit will not determine that it is time to execute the download process, the processing unit determines the timing to execute the download process after a period longer than the certain period has passed.

12. A method for distributing an update program for an on-vehicle control device that controls a target device installed in a vehicle, the method comprising the steps of:
acquiring determination information which is at least one of a communication index relating to a congestion situation of a communication line used for the download, and correlation information correlating with the congestion situation; and
determining, based on the acquired determination information, a timing to execute a download process for the update program at every certain period, wherein
in a case where determination of the timing to execute the download process has not been made and where it is predicted that, even after the certain period, determination of the timing to execute the download process will not be made, the determining step comprises determining the timing to execute the download process after a period longer than the certain period has passed.

13. A non-transitory computer readable storage medium storing a computer program to control download of an update program for an on-vehicle control device that controls a target device installed in a vehicle, the computer program causing the computer to execute the steps of:
acquiring determination information which is at least one of a communication index relating to a congestion situation of a communication line used for the download, and correlation information correlating with the congestion situation; and
determining, based on the acquired determination information, a timing to execute a download process for the update program at every certain period, wherein
in a case where determination of the timing to execute the download process has not been made and where it is predicted that, even after the certain period, determination of the timing to execute the download process will not be made, the determining step comprises determining the timing to execute the download process after a period longer than the certain period has passed.
